(19) United States
(12) Patent Application Publication
(10) Pub. No.: US 2025/0251533 A1
(43) Pub. Date: Aug. 7, 2025

(54) COVER PLATE AND DISPLAY MODULE

(71) Applicant: BOE Technology Group Co., Ltd., Beijing (CN)

(72) Inventors: Biao GAO, Beijing (CN); Zhao LI, Beijing (CN); Xiongnan ZHANG, Beijing (CN); Peng CAI, Beijing (CN); Shiming SHI, Beijing (CN); Song ZHANG, Beijing (CN)

(21) Appl. No.: 18/702,282

(22) PCT Filed: Apr. 27, 2023
(86) PCT No.: PCT/CN2023/091192

§ 371 Date: Apr. 17, 2024

(30) Foreign Application Priority Data
Jun. 20, 2022 (CN) 202210699225.5

(51) Int. Cl. G02B 1/11

(52) U.S. Cl. CPC G02B 1/11

(57) ABSTRACT

A cover plate is divided into planar regions and a bending region connected to the planar regions. The cover plate includes a first flexible planarization layer, an intermediate reinforcing layer and a second flexible planarization layer which are sequentially stacked. The first flexible planarization layer is arranged close to the light exit surface of a display panel. The second flexible planarization layer is arranged away from the display panel. The intermediate reinforcing layer has an open recess extending across the bending region. The cover plate further includes a flexible filler filled in the open recess. The Young's modulus of the intermediate reinforcing layer is greater than the Young's modulus of the first flexible planarization layer and the Young's modulus of the second flexible planarization layer respectively. The Young's modulus of the flexible filler is less than the Young's modulus of the second flexible planarization layer.

### CROSS-REFERENCE TO RELATED APPLICATIONS

The present disclosure claims priority to the Chinese patent application No. 202210699225.5, filed with the China National Intellectual Property Administration (CNIPA) on Jun. 20, 2022, and entitled “COVER PLATE AND DISPLAY MODULE”, the entire contents of which are incorporated herein by reference.

### TECHNICAL FIELD

The present disclosure relates to the technical field of display devices, in particular to a cover plate and a display module.

### BACKGROUND

Currently, a display device which is foldable is a trend for the future. An electronic device contains two planar regions and a bending region connected to the two planar regions. The display device can be folded along the bending region in the middle during use, is convenient for users to store when folded, and provides a larger display region when unfolded, thereby expanding displayed information.

An upper surface of the display device is a flexible display module. The flexible display module 02 provides users with image display, while the users can also use a stylus to perform interactive operations, such as writing and drawing on the flexible display module. The flexible display module is generally of a stacked structure formed by a plurality of layers of functional films, in which a cover plate is placed on an outermost layer to protect other functional layers in the flexible display module, and also needs to have the performances of fingerprint resistance, scratch resistance, etc. In the existing flexible display module, in order to realize the bending function, the cover plate is made of a flexible material, generally a polyimide material, which causes that the mechanical strength of a surface of the flexible display module is reduced, and the tactile sensation is not good and scratches are likely to be produced when the users write on the surface of the flexible display module using the stylus.

### SUMMARY

The present disclosure provides a cover plate and a display module. The above cover plate can meet the bending performance of a bending region while improving the surface strength of the display module.

In order to achieve the above objective, the present disclosure provides the following technical solutions.

A cover plate is divided into planar regions and a bending region connected to the planar regions.

The cover plate includes a first flexible planarization layer, an intermediate reinforcing layer and a second flexible planarization layer which are sequentially stacked. The first flexible planarization layer is configured to be arranged close to a display panel. The second flexible planarization layer is configured to be arranged away from the display panel. The intermediate reinforcing layer has an open recess covering the bending region. A Young's modulus of the intermediate reinforcing layer is greater than a Young's modulus of the first flexible planarization layer and a Young's modulus of the second flexible planarization layer respectively.

The cover plate further includes a flexible filler filled in the open recess, and a Young's modulus of the flexible filler is less than the Young's modulus of the second flexible planarization layer.

The cover plate provided by the embodiments of the present disclosure adopts a multi-film layer composite design, and includes the first flexible planarization layer, the intermediate reinforcing layer and the second flexible planarization layer which are sequentially stacked. The first flexible planarization layer may be arranged close to a light exit surface of the display panel, and the second flexible planarization layer may be arranged away from the display panel. Since the Young's modulus of the intermediate reinforcing layer is greater than the Young's modulus of the first flexible planarization layer and the Young's modulus of the second flexible planarization layer, the surface strength of the display module can be improved, the rigid impact performance and scratch resistance of the display module are improved, the user's writing experience when using a stylus on a surface of the display module can be improved, and the generation of scratches is reduced. Further, the intermediate reinforcing layer has the open recess covering the bending region, the flexible filler is filled in the open recess, and the Young's modulus of the flexible filler is less than the Young's modulus of the second flexible planarization layer, thus the flexibility of the bending region is larger, and the bending performance of the bending region is met while the surface strength of the display module is improved.

Optionally, the open recess penetrates through the intermediate reinforcing layer.

Optionally, side walls of the open recess are in a circular arc transition shape in smooth transition connection with a surface of the intermediate reinforcing layer facing the first flexible planarization layer.

Optionally, the open recess is formed in a side of the intermediate reinforcing layer facing the first flexible planarization layer.

Optionally, a thickness of a portion of the intermediate reinforcing layer located at the bending region in a first direction is less than or equal to thicknesses of the first flexible planarization layer and the second flexible planarization layer in the first direction respectively. The first direction is an arrangement direction of the first flexible planarization layer and the second flexible planarization layer.

Optionally, a distance between two opposite side walls of the open recess is gradually reduced in a direction from a recess opening of the open recess to a recess bottom of the open recess.

Optionally, a recess body of the open recess extends to the planar region(s).

Optionally, a refraction index of the flexible filler is the same as a refraction index of the intermediate reinforcing layer.

Optionally, the flexible filler and the first flexible planarization layer are made of the same material.

Optionally, the first flexible planarization layer and the second flexible planarization layer are made of the same material.

Optionally, the cover plate further includes an anti-reflective film located on a side of the second flexible planarization layer away from the intermediate reinforcing layer.

Optionally, the anti-reflective film is internally doped with refractive particles, and a refraction index of the refractive particles is greater than a refraction index of the anti-reflective film.

Optionally, a concave-convex structure configured to be anti-reflective is arranged on a side of the anti-reflective film close to the second flexible planarization layer.

The present disclosure further provides a display module, including a display panel and any cover plate provided in the above technical solutions, a first flexible planarization layer of the cover plate is arranged close to a light exit surface of the display panel, and a second flexible planarization layer of the cover plate is arranged away from the display panel.

### BRIEF DESCRIPTION OF FIGURES

FIG. 1 is a schematic structural diagram of a display device provided by an embodiment of the present disclosure.

FIG. 2 to FIG. 13 are schematic structural diagrams of a cover plate provided by embodiments of the present disclosure respectively.

FIG. 14 is a schematic structural diagram of an anti-reflective film provided by an embodiment of the present disclosure.

FIG. 15 is a schematic structural diagram of a display module provided by an embodiment of the present disclosure.

### DETAILED DESCRIPTION

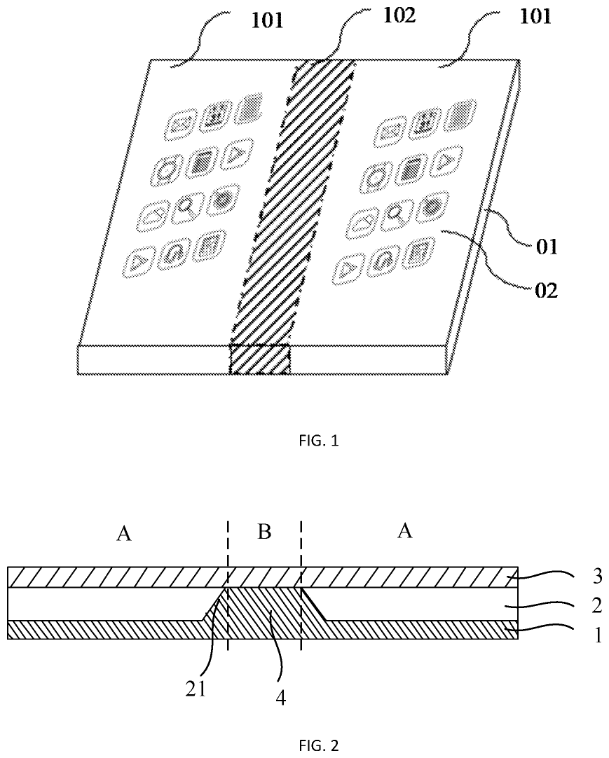

Currently, foldable display devices are a trend for the future. FIG. 1 is a schematic diagram of an electronic device 01 in an unfolded state, including two planar regions 101 and a bending region 102 connected to the two planar regions. The display device can be folded along the bending region 102 in the middle during use, is convenient for users to store when folded, and provides a larger display region when unfolded, thereby expanding displayed information.

An upper surface of the display device is a flexible display module 02. The flexible display module 02 provides users with image display, while the users can also use a stylus to perform interactive operations, such as writing and drawing on the flexible display module. The flexible display module is generally of a stacked structure formed by a plurality of layers of functional films, in which a cover plate is placed on an outermost layer to protect other functional layers in the flexible display module, and also needs to have the performances of fingerprint resistance, scratch resistance, etc. In the existing flexible display module, in order to realize the bending function, the cover plate is made of a flexible material, generally a polyimide material, which causes that the mechanical strength of a surface of the flexible display module is reduced, and the tactile sensation is not good and scratches are likely to be produced when the users write on the surface of the flexible display module using the stylus.

The present disclosure provides a cover plate and a display module, and the cover plate can meet the bending performance of a bending region while improving the surface strength of the display module.

The technical solutions of the embodiments of the present disclosure will be clearly and completely described below with reference to the accompanying drawings of the embodiments of the present disclosure. Apparently, the described embodiments are merely a part of the embodiments of the present disclosure, rather than all the embodiments. Based on the embodiments of the present disclosure, all other embodiments obtained by those of ordinary skill in the art without creative work shall fall within the protection scope of the present disclosure.

Please refer to FIG. 2 to FIG. 13, a cover plate provided by the present disclosure is divided into planar regions A and a bending region B connected to the planar regions A. The cover plate includes a first flexible planarization layer 1, an intermediate reinforcing layer 2 and a second flexible planarization layer 3 which are sequentially stacked. The first flexible planarization layer 1 is configured to be arranged close to a display panel. The second flexible planarization layer 3 is configured to be arranged away from the display panel. The intermediate reinforcing layer 2 has an open recess 21 covering the bending region B. The cover plate further includes a flexible filler 4 filled in the open recess 21. A Young's modulus of the intermediate reinforcing layer 2 is greater than a Young's modulus of the first flexible planarization layer 1 and a Young's modulus of the second flexible planarization layer 3. A Young's modulus of the flexible filler 4 is less than the Young's modulus of the second flexible planarization layer 3.

The cover plate provided by embodiments of the present disclosure adopts a multi-film layer composite design, and includes the first flexible planarization layer 1, the intermediate reinforcing layer 2 and the second flexible planarization layer 3 which are sequentially stacked. The first flexible planarization layer 1 may be arranged close to a light exit surface of the display panel, and the second flexible planarization layer 3 may be arranged away from the display panel. Since the Young's modulus of the intermediate reinforcing layer 2 is greater than the Young's modulus of the first flexible planarization layer 1 and the Young's modulus of the second flexible planarization layer 3, the surface strength of the display module can be improved, the rigid impact performance and scratch resistance of the display module are improved, the user's writing experience when using a stylus on a surface of the display module can be improved, and the generation of scratches is reduced. Meanwhile, the intermediate reinforcing layer 2 has the open recess 21 covering the bending region B, the flexible filler 4 is filled in the open recess 21, and the Young's modulus of the flexible filler 4 is less than the Young's modulus of the second flexible planarization layer 3, so that the flexibility of the bending region is larger, and the bending performance of the bending region B is met while the surface strength of the display module is improved.

Specifically, as for the partitioning of the cover plate, the cover plate may have at least two planar regions A and one bending region B connected to the two planar regions, as shown in FIG. 1 to FIG. 13; or the cover plate may have three or more planar regions A and bending regions B connected to every two adjacent planar regions A; or the cover plate may have other partitioning situations that achieve other bending forms, which is not shown herein and is determined according to the actual situation.

When the above cover plate is manufactured, the intermediate reinforcing layer 2 may be made first, and then the flexible filler 4, the first flexible planarization layer 1 and the second flexible planarization layer 3 are formed on the intermediate reinforcing layer 2. The first flexible planarization layer 1 and the second flexible planarization layer 3 can enable two sides of the intermediate reinforcing layer 2 to be flattened.

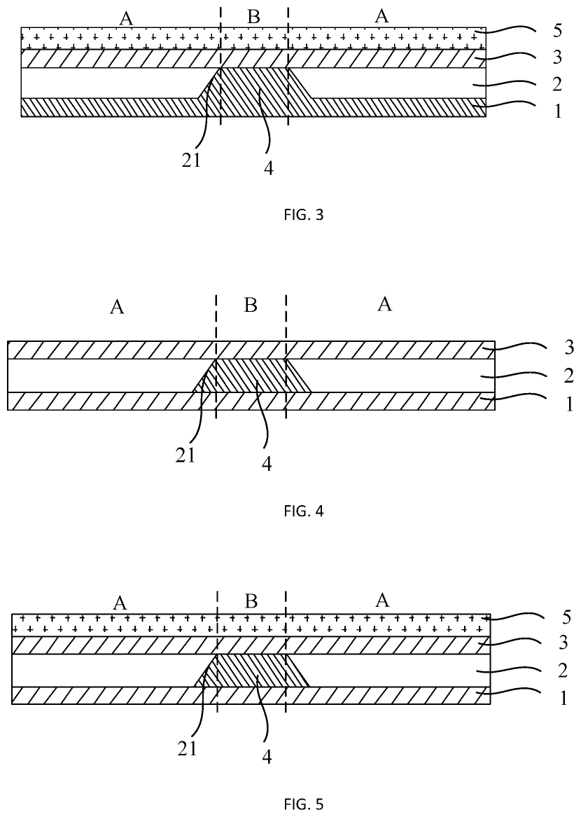

In the cover plate provided by embodiments of the present disclosure, as shown in FIG. 2, FIG. 3, FIG. 4, and FIG. 5, the open recess 21 may be a through groove penetrating through the intermediate reinforcing layer 2. That is, the intermediate reinforcing layer 2 is disconnected at the bending region B. The flexible filler 4 is filled in the middle of the disconnected intermediate reinforcing layer 2, and the bending performance of the bending region B can be better ensured.

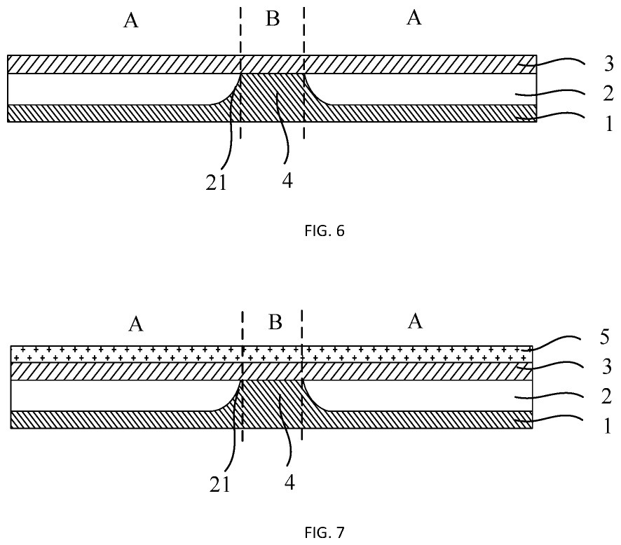

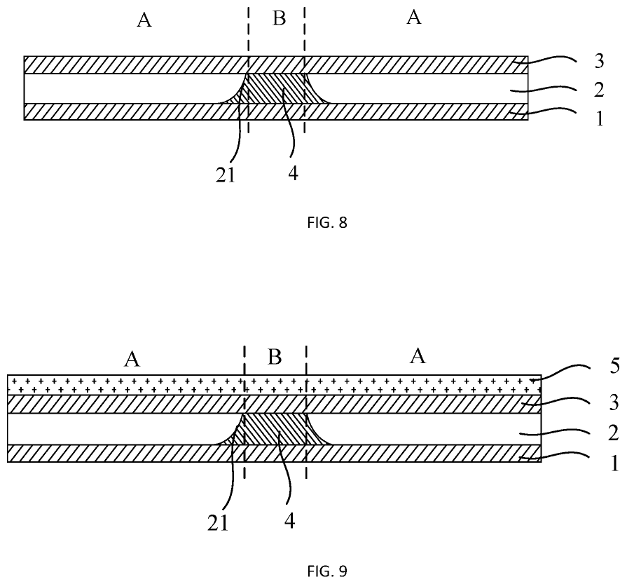

In the case where the intermediate reinforcing layer 2 is disconnected at the bending region B, as shown in FIG. 6, FIG. 7, FIG. 8, and FIG. 9, side walls of the open recess 21 are in a circular arc transition shape in smooth transition connection with a surface of the intermediate reinforcing layer 2 facing the first flexible planarization layer 1. The circular arc transition shape can reduce the undesirable optical effects caused by the splicing state of the intermediate reinforcing layer 2, and can improve the optical consistency of the display module.

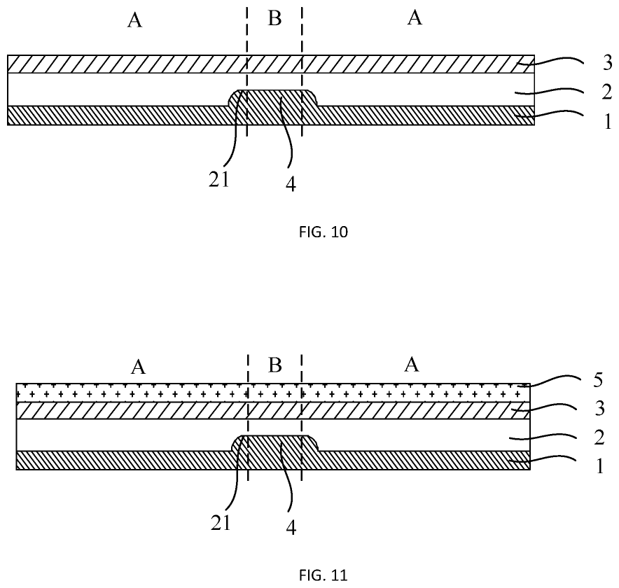

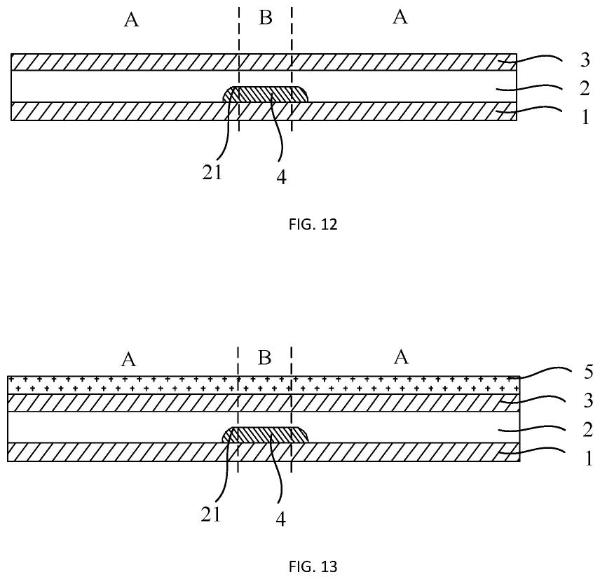

In addition, the open recess 21 may be arranged as a groove, as shown in FIG. 10, FIG. 11, FIG. 12, and FIG. 13, the open recess 21 is formed in one side of the intermediate reinforcing layer 2 facing the first flexible planarization layer 1, or the open recess 21 is formed in one side of the intermediate reinforcing layer 2 facing the second flexible planarization layer 3. That is, the intermediate reinforcing layer 2 is of a non-disconnected design. The portion of the intermediate reinforcing layer 2 at the bending region B may be etched and thinned to realize the bending performance of the bending region B, which is not limited herein and determined according to the actual situation.

Specifically, after the portion of the intermediate reinforcing layer 2 at the bending region B is etched and thinned, a thickness of the portion of the intermediate reinforcing layer 2 at the bending region B in a first direction is less than or equal to the thickness of the first flexible planarization layer 1 and the thickness of the second flexible planarization layer 3 in the first direction respectively, and the bending performance of the bending region B can be improved. The first direction is an arrangement direction of the first flexible planarization layer 1 and the second flexible planarization layer 3, that is, a vertical direction in the figures.

In the cover plate provided by embodiments of the present disclosure, a recess body of the open recess 21 may extend to the planar regions A, thereby enlarging the filling range of the flexible filler 4, and better ensuring the bending performance of the bending region B.

In the cover plate provided by embodiments of the present disclosure, a distance between two opposite side walls of the open recess 21 is gradually reduced in a direction from a recess opening (referring to one side adjacent to the first flexible planarization layer 1) of the open recess 21 to a recess bottom (referring to one side adjacent to the second flexible planarization layer 3), so that it is ensured that an interior of the open recess 21 is fully filled when the flexible filler 4 is applied.

In the cover plate provided by embodiments of the present disclosure, a refraction index of the material of the flexible filler 4 and a refraction index of a material of the intermediate reinforcing layer 2 need to be as close as possible, which can reduce the optical interference problem caused by the difference in material of a transition region between the bending region B and the planar regions A, and can improve the optical consistency of the display module. For example, the refraction index of the flexible filler 4 may be the same as the refraction index of the intermediate reinforcing layer 2, and a specific value of the refraction index of the material may be set as 1.5.

In the cover plate provided by embodiments of the present disclosure, the flexible filler 4 and the first flexible planarization layer 1 may be made of the same material. For example, the first flexible planarization layer 1 and the flexible filler 4 may be made of rubber (TPU) with a modulus of about 10 MPa to 500 MPa or other polymer materials. The intermediate reinforcing layer 2 may be made of glass with a modulus of about 50 GPa to 90 GPa or other high-hardness materials. The second flexible planarization layer 3 may be made of polyimide (PI) with a modulus of about 2 GPa to 8 GPa or other polymer materials.

As shown in FIG. 2, FIG. 3, FIG. 6, FIG. 7, FIG. 10, and FIG. 11, when the open recess 21 penetrates through the intermediate reinforcing layer 2 or when the open recess 21 is located in the side of the intermediate reinforcing layer 2 adjacent to the first flexible planarization layer 1, the flexible filler 4 and the first flexible planarization layer 1 may be fabricated in a single process, and the fabrication process is saved.

Optionally, the flexible filler 4 and the first flexible planarization layer 1 may be made of different materials, which is not limited herein and determined according to the actual situation.

Optionally, as shown in FIG. 4, FIG. 5, FIG. 8, FIG. 9, FIG. 12, and FIG. 13, the first flexible planarization layer 1 and the second flexible planarization layer 3 may be made of the same material. For example, the first flexible planarization layer 1 and the second flexible planarization layer 3 may be made of polyimide (PI) with a modulus of about 2 GPa to 8 GPa or other polymer materials. The first flexible planarization layer 1 and the second flexible planarization layer 3 are formed on surfaces of two sides of the intermediate reinforcing layer 2 by a coating process. The intermediate reinforcing layer 2 may be made of glass with a modulus of about 50 GPa to 90 GPa or other high-hardness materials. The flexible filler 4 may be made of rubber (TPU) with a modulus of about 10 MPa to 500 MPa or other polymer materials.

In the cover plate provided by embodiments of the present disclosure, the thickness of the first flexible planarization layer 1 may be 30 μm to 80 μm, and the thickness of the portion of the intermediate reinforcing layer 2 at the planar regions A may be 80 μm to 300 μm. When the intermediate reinforcing layer 2 is not disconnected at the bending region B, the thickness of the portion of the intermediate reinforcing layer 2 at the bending region B may be 30 μm to 80 μm, and the thickness of the second flexible planarization layer 3 may be 30 μm to 80 μm. Optionally, the specific thicknesses of the first flexible planarization layer 1, the intermediate reinforcing layer 2 and the second flexible planarization layer 3 are not limited herein and determined according to the actual situation.

Specifically, at an edge of the cover plate, the first flexible planarization layer 1, the intermediate reinforcing layer 2 and the second flexible planarization layer 3 may be flush or not flush. When the first flexible planarization layer 1, the intermediate reinforcing layer 2 and the second flexible planarization layer 3 are not flush, the first flexible planarization layer 1 and the second flexible planarization layer 3 may be inwardly retracted with respect to the intermediate reinforcing layer 2 or may extend beyond an edge of the intermediate reinforcing layer 2 to wrap the edge of the intermediate reinforcing layer 2.

The cover plate provided by embodiments of the present disclosure, as shown in FIG. 3,

FIG. 5, FIG. 7, FIG. 9, FIG. 11, and FIG. 13, may further include an anti-reflective film 5 located on one side of the second flexible planarization layer 3 away from the intermediate reinforcing layer 2, for example, an AG film, which can reduce the optical interference problem caused by the difference in material of the transition region between the bending region B and the planar regions A, and can improve the optical consistency of the display module. A thickness of the anti-reflective film 5 may be 30 μm to 80 μm, and the specific value may be determined according to the actual situation.

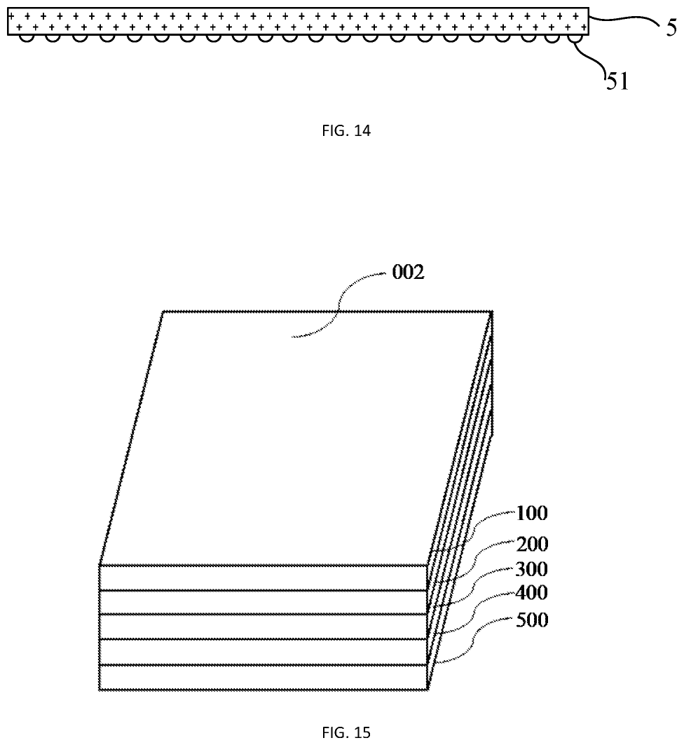

Specifically, the above anti-reflective film 5 may be internally doped with refractive particles, and a refraction index of the refractive particles is greater than a refraction index of the anti-reflective film. Or, a concave-convex structure configured to be anti-reflective is arranged on one side of the anti-reflective film 5 close to the second flexible planarization layer 3, as shown in FIG. 14, the concave-convex structure may be protrusions 51 distributed in an array, and the shapes of the protrusions may be hemispherical, serrated, or square, etc., which will not be limited herein and are determined according to the actual situation.

The present disclosure further provides a display module, including a display panel and any cover plate provided in the above technical solution. The first flexible planarization layer 1 of the cover plate is arranged close to the display panel, and the second flexible planarization layer 3 of the cover plate is arranged away from the display panel.

Specifically, the above display module is specifically a flexible display module, as shown in FIG. 15, the display module 002 from top to bottom may include: a cover plate 100, which is placed on the outermost layer to protect other functional layers in the module, and further has the performances of fingerprint resistance, scratch resistance, etc.; an optical adhesive layer 200, which bonds the cover plate 100 with a polarizer 300; the polarizer 300, which is used for reflection prevention of the display module, some display module structures having no polarizer; a display panel 400, which can provide display and touch control functions, and is specifically a flexible display panel; and a support member 500, generally matched with film layers together to provide support for the module. Optionally, the display module may also be of other structures, which is not limited herein and determined according to the actual situation.

It is apparent that those skilled in the art can make various modifications and variations on the embodiments of the present disclosure without departing from the spirit and scope of the present disclosure. In this way, if these modifications and variations of the present disclosure fall within the scope of the claims of the present disclosure and equivalent technologies thereof, the present disclosure is also intended to include these modifications and variations.

1. A cover plate, wherein the cover plate is divided into planar regions and a bending region connected to the planar regions;
the cover plate comprises a first flexible planarization layer, an intermediate reinforcing layer and a second flexible planarization layer which are sequentially stacked; the first flexible planarization layer is configured to be arranged close to a display panel, the second flexible planarization layer is configured to be arranged away from the display panel, the intermediate reinforcing layer has an open recess covering the bending region, and a Young's modulus of the intermediate reinforcing layer is greater than a Young's modulus of the first flexible planarization layer and a Young's modulus of the second flexible planarization layer respectively; and
the cover plate further comprises a flexible filler filled in the open recess, and a Young's modulus of the flexible filler is less than the Young's modulus of the second flexible planarization layer.

2. The cover plate according to claim 1, wherein the open recess penetrates through the intermediate reinforcing layer.

3. The cover plate according to claim 2, wherein side walls of the open recess are in a circular arc transition shape in smooth transition connection with a surface of the intermediate reinforcing layer facing the first flexible planarization layer.

4. The cover plate according to claim 1, wherein the open recess is formed in one side of the intermediate reinforcing layer facing the first flexible planarization layer.

5. The cover plate according to claim 4, wherein a thickness of a portion of the intermediate reinforcing layer located at the bending region in a first direction is less than or equal to a thickness of the first flexible planarization layer and a thickness of the second flexible planarization layer in the first direction respectively, and the first direction is an arrangement direction of the first flexible planarization layer and the second flexible planarization layer.

6. The cover plate according to claim 1, wherein a distance between two opposite side walls of the open recess is gradually reduced in a direction from a recess opening of the open recess to a recess bottom of the open recess.

7. The cover plate according to claim 1, wherein a recess body of the open recess extends to the planar region.

8. The cover plate according to claim 1, wherein a refraction index of the flexible filler is same as a refraction index of the intermediate reinforcing layer.

9. The cover plate according to claim 1, wherein the flexible filler and the first flexible planarization layer are made of a same material.

10. The cover plate according to claim 1, wherein the first flexible planarization layer and the second flexible planarization layer are made of a same material.

11. The cover plate according to claim 1, wherein the cover plate further comprises an anti-reflective film on one side of the second flexible planarization layer away from the intermediate reinforcing layer.

12. The cover plate according to claim 11, wherein the anti-reflective film is internally doped with refractive particles, and a refraction index of the refractive particles is greater than a refraction index of the anti-reflective film.

13. The cover plate according to claim 11, wherein a concave-convex structure configured to be anti-reflective is arranged on a side of the anti-reflective film close to the second flexible planarization layer.

14. A display module, comprising a display panel and the cover plate according to claim 1, wherein the first flexible planarization layer of the cover plate is arranged close to the display panel, and the second flexible planarization layer of the cover plate is arranged away from the display panel.
